(19) United States
(12) Patent Application Publication
(10) Pub. No.: US 2001/0014265 A1
(43) Pub. Date: Aug. 16, 2001

(54) Process for casing a book block or paper-cover block into a cover, and device for performing the process

(76) Inventors: Thorsten Holtmeir, Bunde (DE); Gunther Knittel, Bad Iburg (DE)

Correspondence Address: ALIX YALE & RISTAS LLP, 750 MAIN STREET, SUITE 600, HARTFORD, CT, 06103

(21) Appl. No.: 09/773,096

(22) Filed: Jan. 31, 2001

(30) Foreign Application Priority Data
Feb. 12, 2000 (DE) 100 06 334.9
May 17, 2000 (DE) 100 24 068.2

(51) Int. Cl. B42C 11/00

(52) U.S. Cl. 412/5

(57) ABSTRACT

In a process for casing a book block or paper-cover block into a cover during the manufacture of adhesively bound books, paper covers or magazines in an adhesive binding machine in which the block is transported, with a hanging-out portion, in a block clamp belonging to a transport system and is connected to the cover by gluing the back and/or the side regions, provision is made, in order to achieve an increase in quality, for the hanging-out portion (1a) of the block (1) to be aligned with the back region (2a), which is preferably predetermined by scoring, of a cover (2) which is fed in, and for the said cover (2) to be pressed against the back and/or the side regions of the block (1).

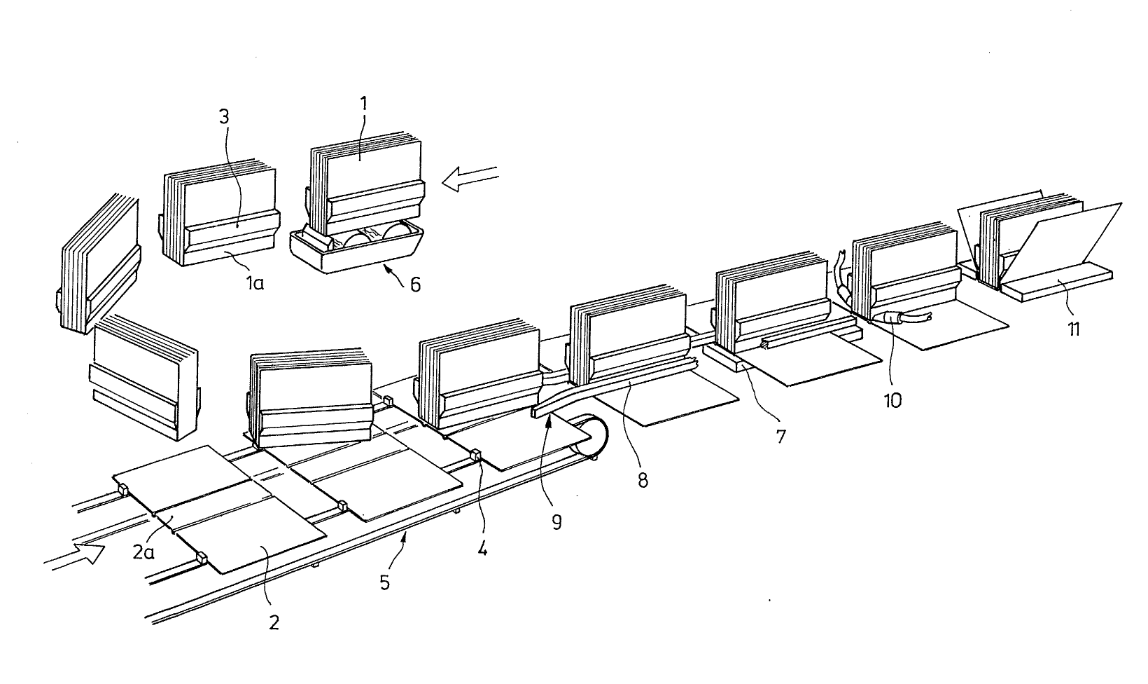

### BACKGROUND OF THE INVENTION

The invention relates to a process, and to a device for performing the process, for casing a book block or paper-cover block into a cover during the manufacture of adhesively bound books, paper covers and magazines in an adhesive binding machine.

In an adhesive binding machine for manufacturing books, paper covers or magazines, leaves or folded sheets which have been gathered together are transported, with a defined hanging-out portion, in block clamps belonging to a transport system, and are connected to form a book block or paper-cover block by the application of an adhesive to the machined back of the block. The connection of a scored cover to the book block or paper-cover block which has previously been provided with a lateral coating of glue, the so-called “casing-in” operation, takes place in a cover laying-on and pressing-on arrangement, the said cover being pressed against the back of the block and adjoining side regions during the continuous movement of the book block or paper-cover block.

Instead of the normal procedure of coating the spine of the block which are used herein refers to the back of the block and/or its adjoining side regions with glue by means of rollers and discs, the adhesive can also be applied to the cover using nozzles, in a manner corresponding to the breadth of the back of the block and of the side regions to be coated with glue.

As a result of various correlations and influences in the pre-production process, a more or less pronounced expansion occurs in the back of the block, the so-called “mushroom formation”, which may also have an asymmetrical shape. As experience shows, this not infrequently leads, when the cover and block are joined, to inaccurate centring of the back of the block in relation to the scoring on the cover or in relation to the bent edges. The consequence of this is an inferior quality of the product, such as an unsightly shape for the back, a title impression which extends at an angle in relation to the edge of the back, and also the formation of folds on the first and last pages of the block when the cover is pressed on laterally. The said formation of folds can also occur in so far as the pressed-on sides of the cover, after being released by the pressing-on station, detach themselves from the adhesive bond, together with the first and last pages, as a result of the recovery forces of the cover. Because of the sticking power of the adhesive between the applying discs of the adhesive-applying device and the sides of the block, there is also the risk, particularly in the case of thin papers, of the outer leaves or layers coming off the block, something which can likewise entail the formation of folds during the pressing-on operation. All this not only affects the quality of the books, paper covers or magazines, but also has an adverse effect on the adhesion.

The object of the invention consists in proposing, while avoiding the disadvantages of the prior art, a process for casing a book block or paper-cover block into a cover during the manufacture of adhesively bound books, paper covers or magazines in an adhesive binding machine, and a device for performing the said process, with the aid of which process and device a substantial increase in the quality of the products can be made possible.

This is achieved by means of the invention in a surprisingly simple manner through the fact that, according to a first idea of the invention, the hanging-out portion of the block is aligned with the back region, which is preferably predetermined by scoring, of a cover which is fed in, and the said cover is pressed against the spine of the block which includes the back and/or the side regions of the block.

According to a second idea of the invention, the block is coated with glue on the back, the hanging-out portion is optionally aligned with the back region of the cover which is fed in, the said cover is pressed against the back, and the side regions of the block or of the cover are thereupon coated with glue and the cover is pressed on laterally.

In order to perform the process, a centring arrangement is provided which acts, from opposite sides, on the hanging-out portion of a block transported in a block clamp belonging to an adhesive binding machine, and aligns the said block with the centre of the block clamp. Further features of the process and device emerge from the dependent claims.

With the aid of the process and of the device for performing the process, it is possible to manufacture adhesively bound books, paper covers or magazines, which are of high quality in respect of both aesthetics and also physical properties. It is particularly advantageous if, before the cover is pressed on, the hanging-out portion of the book block or paper-cover block is aligned, in a positionally precise manner, with the back region of the cover, which back region is preferably predetermined by scoring. As a result of this, the first and last pages of the book block or paper-cover block are always located exactly between the scoring on the back.

The invention will be explained in greater detail below with the aid of the drawing, in which a bookbinding machine with a centring arrangement according to the invention is diagrammatically represented, on an exemplary basis, in a perspective view.

In a bookbinding machine, a so-called adhesive binder, for manufacturing adhesively bound paper covers, it is possible to make out a multitude of block clamps 3, which are disposed at identical distances from one another, for clamping-in blocks 1 with a defined hanging-out portion 1a. As is known, the block clamps 3 are located, guided in tracks, on a continuous chain belonging to a transport system and running around rerouting chain wheels, and are fastened in a movable manner, drive-wise, to the points of articulation of the chain links.

In order to case a block 1 into a cover 2, the latter is fed from below, by the rear engagement of transporters 4 carried on a conveyer 5 and while aligned with a reference edge, to the block 1 which has been previously coated with glue on the back by means of an adhesive-applying arrangement 6, and in the process, the hanging-out portion 1a of the block is aligned with the back region 2a, which is preferably predetermined by scoring, in a positionally precise manner and is pressed against the back of the block 1 by a pressure-applying table 7.

According to the invention, stationary centring rails 8, which align the hanging-out portion 1a of a block 1, which is fed in the block clamp 3, with the centre of the said block clamp 3 from opposite sides, are located between the block clamps 3 and the pressure-applying table 7 at a distance from one another which corresponds to the thickness of the block.

In the initial region, the centring rails 8 form a run-in section 9 which takes over the hanging-out portion 1a of the block 1 directly from the rerouting device of the transport system and brings it to the center of the block clamp 3. Instead of the centring rails 8, use may be made, for the purpose of aligning the hanging-out portion 1a of the block 1, of mutually opposed rows of freely rotatable rollers belonging to a roller track with a suitable run-in section. The distance of the centring rails 8 or rows of rollers from one another can be set to the particular thickness of the block 1.

Nozzles 10, which apply a strip of adhesive to the side regions of the block 1, are disposed after the centring rails 8, and the lateral pressing-on of the cover 2 by pressing-on rails 11 then takes place as the procedure continues.

The invention is not restricted to the exemplified embodiment represented and described. Instead of the application of adhesive to the back and the side regions of the block 1, or only to the side regions in the case of products with a hollow back, the adhesive may also be applied to the cover 2 via nozzles, and the adjustment of the hanging-out portion of the block 1 in the block clamp 3 takes place afterwards, with subsequent pressing-on against the back and/or against the side regions of the block 1. What is essential is that the hanging-out portion of the block 1 is aligned with the back region 2a of the scored cover 2 in a positionally precise manner, before connection to the cover 2 takes place.

According to a second concept of the invention in the case of the process, in order to avoid the formation of folds on the first and last pages of the block, the said block is first of all coated with glue on the back and the cover pressed against the back of the block. The coating of the side regions with glue and the lateral pressing-on of the cover take place after that. In the case of strong papers, it is possible to omit alignment of the hanging-out portion of the block. What is essential is the pressing-on of the cover against the back of the block before the coating of the side regions with glue, as a result of which detachment of the first and last pages of the block from the adhesive bond by the adhesive-applying discs is prevented.

What is claimed:

1. Process for casing a book block having a spine that includes a back surface and adjacent side surface or paper-cover block, having a spine that includes a back surface and adjacent side surface into a cover during the manufacture of adhesively bound books, paper covers or magazines in an adhesive binding machine in which the block is transported, with a hanging-out portion, in a block clamp belonging to a transport system and is connected to the cover by gluing at least a part of the spine of the back characterised in that the hanging-out portion (1a) of the block (1) is aligned with the back region (2a), which is preferably predetermined by scoring, of a cover (2) which is fed in, and the said cover (2) is pressed against at least a part of said spine of the block (1).

2. Process according to claim 1, characterised in that the block (1) is coated with glue on the back, the hanging-out portion (1a) is optionally aligned with the back region (2a) of the cover (2) which is fed in, and the said cover (2) is pressed against the back, and that the side regions of the block (1) or of the cover (2) are thereupon coated with glue and the cover is pressed on laterally.

3. Process according to claim 2, characterised in that the adhesive is applied by nozzle (10) to the side regions of the block (1) or of the cover (2).

4. Process according to claim 1, characterised in that adhesive is applied to the back region and/or the side regions of the cover (2), the hanging-out portion (1a) of the block (1) is aligned with the back region (2a) of a cover (2) which is fed in, and the said cover (2) is pressed against the back of the block (1) and/or the side regions.

5. Device for performing the process according to one of claims 1, characterised by a centring arrangement (8, 9) which acts, from opposite sides, on the hanging-out portion (1a) of a block (1) transported in a block clamp (3) belonging to an adhesive binding machine, and aligns the said block with the center of the block clamp (3).

6. Device according to claim 5, characterised in that the centring arrangement consists of centring rails (8) acting on the hanging-out portion (1a) of the block (1).

7. Device according to claim 5, characterised in that the centring arrangement consists of a multitude of freely rotatable rollers belonging to roller tracks, which rollers run on the hanging-out portion (1a) of the block (1).

8. Device according to claim 6, characterised in that the distance of the centring rails (8) or roller tracks from one another can be set to the thickness of the block (1).

9. Device according to one of claims 5, characterised in that the centring device (8, 9) has a run-in section (9), which takes over the hanging-out portion (1a) of the block (1) from the rerouting device of the transport system and brings it to the center of the block clamp (3).

10. Device according to one of claims 5, characterised in that the centring arrangement (8, 9) is disposed above a cover pressing-on arrangement (7) for pressing-on the cover (2) against the back of the block (1).

11. Device according to one of claims 5, characterised by an arrangement (6), which is disposed before the centring arrangement (8, 9) and the cover pressing-on arrangement (7), for applying an adhesive to the back of the block (1), and by an arrangement (10), which is disposed after the centring arrangement (8, 9) and cover pressing-on arrangement (7), for applying an adhesive to the side regions of the block (1), and by a cover pressing-on arrangement (11) for pressing-on the cover (2) laterally against the block (1).

12. Device according to claim 1 1, characterised by nozzles (10) for applying an adhesive to the side regions of the block (1) or of the cover (2).

13. A method for casing a block selected from the group consisting of book blocks and paper cover blocks into a cover which comprises:
providing a plurality of blocks, each of said blocks having a spine, each spine comprising a back and adjacent side regions in of said block;
providing a plurality of book clamps dimensioned and configured for cooperation with each of said blocks,
clamping each of said blocks with the spine of each block disposed in depending relationship to the book clamp;
providing a plurality of covers dimensioned and configured for cooperation with each of said blocks,
defining a back region on each of said covers that is dimensioned and configured for cooperation with at least a part of the spine of each of the plurality of blocks;
coating the backs of respective blocks with a glue and;
aligning the backs of respective blocks with respect to back regions of individual covers;
pressing the backs of respective blocks against the back regions of respective covers; and
coating said side regions of respective blocks with glue; and
pressing portions of respective covers against the side regions of respective blocks.

14. A method for casing a block selected from the group consisting of book blocks and paper cover blocks into a cover which comprises:
providing a plurality of blocks, each of said blocks having a spine, each spine comprising a back and adjacent side regions in of said block;
providing a plurality of book clamps dimensioned and configured for cooperation with each of said blocks,
clamping each of said blocks with the spine of each block disposed in depending relationship to the book clamp;
providing a plurality of covers dimensioned and configured for cooperation with each of said blocks,
defining a back region on each of said covers that is dimensioned and configured for cooperation with at least a part of the spine of each of the plurality of blocks;
coating the backs of respective blocks with a glue;
aligning the backs of respective blocks with respect to back regions of individual covers;
pressing the backs of respective blocks against the back regions of respective covers; and
coating with glue portions of respective covers that abut the side regions of respective blocks in a cased block; and
pressing portions of respective covers against the side regions of respective blocks.

15. A method in accordance with claim 14, wherein said step of coating with glue portions of respective covers that abut the side regions of respective blocks in a cased block is achieved by the use of at least one nozzle to spray the glue.

16. A method for casing a block selected from the group consisting of book blocks and paper cover blocks into a cover which comprises:
providing a plurality of blocks, each of said blocks having a spine, each spine comprising a back and adjacent side regions in of said block;
providing a plurality of book clamps dimensioned and configured for cooperation with each of said blocks,
clamping each of said blocks with the spine of each block disposed in depending relationship to the book clamp;
providing a plurality of covers dimensioned and configured for cooperation with each of said blocks,
defining a back region on each of said covers that is dimensioned and configured for cooperation with at least a part of the spine of each of the plurality of blocks;
coating with glue the the back region on each of said covers;
aligning the backs of respective blocks with respect to back regions of individual covers;
pressing the backs of respective blocks against the back regions of respective covers.

17. A method in accordance with claim 16, wherein said step of coating with glue the back region on each of said covers is achieved by the use of at least one nozzle to spray the glue.

18. A method for casing a block selected from the group consisting of book blocks and paper cover blocks into a cover which comprises:
providing a plurality of blocks, each of said blocks having a spine, each spine comprising a back and adjacent side regions in of said block;
providing a plurality of book clamps dimensioned and configured for cooperation with each of said blocks,
clamping each of said blocks with the spine of each block disposed in depending relationship to the book clamp;
providing a plurality of covers dimensioned and configured for cooperation with each of said blocks,
defining a back region on each of said covers that is dimensioned and configured for cooperation with at least a part of the spine of each of the plurality of blocks;
coating with glue portions of respective covers that abut the side regions of respective blocks in a cased block;
aligning the backs of respective blocks with respect to back regions of individual covers;
pressing the sides of respective covers against the sides of respective blocks.

19. A method in accordance with claim 18, wherein said step of coating with glue portions of respective covers that abut the side regions of respective blocks in a cased block is achieved by the use of at least one nozzle to spray the glue.

20. An apparatus for casing associated book blocks and paper cover blocks which comprises:
a plurality of book clamps, each of said book clamps being dimensioned and configured for clamping an associated book block or paper cover blocks with the back thereof disposed in depending relationship to one of said book clamps;
means for transporting each of said book clamps with said back disposed in depending relation to the book clamp carrying said block; and
means for transporting a plurality of covers each having a back region;
means for positioning parts of respective block backs and parts of covers in registered relationship; and
means for applying glue to some of said parts that are disposed in registered relationship.

21. The apparatus in accordance with claim 20, wherein said means for positioning parts of respective block backs and parts of covers in registered relationship includes stationary centering rails disposed on opposed sides of respective block backs carried in respective book clamps.

22. The apparatus in accordance with claim 20, wherein said means for positioning parts of respective block backs and parts of covers in registered relationship includes a plurality of rollers disposed on opposed sides of respective block backs carried in respective book clamps.

23. The apparatus in accordance with claim 21, further including means for adjusting the distance between stationary centering rails disposed on opposed sides of respective block backs is adjustable.

24. The apparatus in accordance with claim 23, further including means for pressing respective covers against said blocks.

25. The apparatus in accordance with claim 24, wherein said means for applying glue includes at least one nozzle disposed for spraying glue on portions of the covers.
